(19) United States
(12) Patent Application Publication
(10) Pub. No.: US 2010/0124861 A1
(43) Pub. Date: May 20, 2010

(54) METHOD FOR THE PRODUCTION OF A BIOACTIVE CELLULOSE FIBER WITH A HIGH DEGREE OF WHITENESS

(76) Inventors: Frank Wendler, Jena (DE); Axel Kolbe, Neundorf (DE); Reiner Büttner, Rudolstadt (DE); Hardy Markwitz, Rudolstadt (DE)

Correspondence Address: Horst M. Kasper, 13 Forest Drive, Warren, NJ, 07059, US

(21) Appl. No.: 12/451,113

(22) PCT Filed: Apr. 15, 2008
(86) PCT No.: PCT/DE2008/000642

§ 371 Date: Jan. 11, 2010

(30) Foreign Application Priority Data
Apr. 25, 2007 (DE) 10 2007 019 768.5

(51) Int. Cl. B32B 5/02; D01F 1/02; A01N 59/16

(52) U.S. Cl. 442/123; 264/211; 424/618; 977/961

(57) ABSTRACT

The invention relates to a method for the production of cellulose shaped bodies according to the dry-wet extrusion method (Lyocell method) with high degree of whiteness and bioactive action for use in the textile sector and paper production. In the context of the invention, the term “bioactive” refers to antimicrobial efficacy, based on the antibacterial action of the element silver, which is used as nanoscale reagent for increasing the efficacy thereof. The chemically inert and, at the same time, bactericidal effect is used in the production of sports and leisure clothing with a high degree of whiteness and papers with a long shelf life. Use is possible in the medical sector, for example, for wound dressings, textiles for hospitals, and in the filter and packaging industry.

The invention relates to a method for the production of cellulose shaped bodies according to the dry-wet extrusion method (Lyocell method) with bioactive action and, at the same time, a high degree of whiteness for use in the clothing sector and paper production. In the context of the invention, the term “bio-active” refers to antimicrobial efficacy which is based on the bactericidal action of the element silver, which is used as a nanoscale reagent for increasing the efficacy thereof. Its chemically inert and, at the same time, bactericidal effect is used in the production of sports and leisure clothing and papers with a long shelf life. Use is possible in the medical sector, for example, for wound dressings, textiles for hospitals, and in the filter and packaging industry.

### PRIOR ART

The development of anti-infective and anti-microbial materials for medicine and technique finds an increasing importance since organic antibiotics, even so-called wide-spectrum antibiotics, do not offer a sufficient protection against the enormous variety of pathogenic bacteria and germs. Moreover, some strains of bacteria have set up resistances towards antibiotics during a more than fifty years application of the latter. It is known that heavy metal ions such as, for example, silver ions, mercury ions, copper ions, zinc ions or zirconium ions have a destructive or repressive effect on micro-organisms [Thurman et al., CRC Crit. Rev. in Environ. Contr. 18 (4), p. 295-315 (1989)]. As concerns a bactericidal effect, silver ions are of particular interest. Having a broad activity spectrum and being substantially toxicologically harmless to the human organism, silver is now used more frequently as a natural alternative to antibiotics. Microorganisms such as bacteria, spores, mould and other fungi are destructed by contact with silver. The attack takes place in such way that the enzymes which transport the nutritious substance to the cell are destroyed, the cell membrane and the cell plasm are destabilized and, finally, the cell division and the cell proliferation are disturbed [Horn, Fraunhofer Magazine 1, (2003)]. The bactericidal effective concentration with silver is given by 0.01-1 mg/l [Ullmann's Encyclopedia of Industrial Chemistry, 5^{th} edition, Volume A, p. 160, VCH (1993)].

The effect of the silver ions is utilized in very different applications. As generally known the silver can take effect as a gel suspension or in fibers and on fibers, respectively. In WO2007/017901 a gel compound with nanoscale silver particles is described for direct wound treatment. Also in WO2006/092155 nano-silver is used in ointments and tooth pastes. In DE60022344 anti-microbial body hygiene products which comprise nano-silver on/in a polymer matrix are disclosed. US2002/0145132 describes the dispersion of nanoscale metal precursor particles in a polymer matrix (inter alia also cellulose) with subsequent evaporation of the solvent, reduction of the metal precursor particles and the fixation of the latter in the matrix by means of UV-radiation. The molar ratio of metal to matrix is at least 1:100.

In the course of manufacture of textile fibers, silver is applied to the surface, for example, galvanically or by a binder. WO2006/094098 describes a wound healing means with a surface silver coating consisting of a compound which sets free silver ions and a binding agent. The processing of galvanic silvered polyamide silk in knitting machines and weaving machines is critical, since the silver layer of the polyamide silk partially deposits on the thread guiding elements which consequently very often leads to machine down times.

A further known possibility is the insertion of metallic silver, silver zeolite or glass-ceramics into a fiber matrix of melt-extruded fibers such as, for example, polypropylene fibers, polyester fibers or polyamide fibers [Taschenbuch für die Textilindustrie, p. 124 ff, Schiele & Schön, Berlin (2003)]. The use of silver-zeolite and silver glass-ceramics has also been proposed for acrylic fibers.

Cellulosic fibers having bacteriostatic or bactericidal properties are also used. A fiber is obtained by incorporating silver ions into an alginic-carboxymethyl cellulose matrix, thereby the silver ions are bound to water insoluble ceramic ion-exchange resin particles. Said fiber exhibits an anti-microbial effect according to DE60119150.

In WO2005/073289 nano-particles are inserted into a cellulose fiber. Said fibers exhibit bactericidal properties, however, concentrations in a range of 0.1 to 15 mass-% are necessary. Furthermore, the fiber shows a discoloration in the range from light to dark brown and the intermixing of the metal nano-particles is a strong exothermic process, a cooling to temperatures below 120° C. is strictly required. The nano-particles are preferably fed in powder form; minor agglomerations are just accepted.

RU2256675 proposes the deposition of silver in the form of silver nitrate upon cellulose. In order to raise the content of silver, ammonia and/or glycerol are added to the silver nitrate solution. However, to obtain a permanent effect of the silver ions on the cellulose, very large amounts of silver nitrate are required.

More advantageous, however, seems to be to apply silver nitrate on a Lyocell-fiber which, according to DE 10315749, has been modified by an ion exchanger. According to this method, textile fibers can be produced which, due to a controllable depot effect, are capable to emit silver ions. By virtue of the comparatively high loading density of about 80,000 mg silver per kg fiber, fibers may be obtained which can be blended with other fibers to about the 200-fold and can be processed to yarns which with about 400 ppm of silver still show a bactericidal effect. The disadvantages of this method are the additional operational step of depositing silver nitrate and the later color change of the fiber. Even after blending, the manufacture of white products is not possible.

DE 10140772 describes a method for producing cellulosic shaped bodies incorporating algae. The shaped bodies are capable to adsorb metals from heavy metal containing matter. The heavy metal containing shaped bodies can be used as bactericidal and/or fungicidal material. The concentration of the adsorbed heavy metals in the cellulosic shaped bodies is given by at least 70 mg/kg related to the total weight. There is further specified that a silver rate of 1855 mg/kg fiber was obtained by immersing the fiber, which has a brown algae content of 11.39 mass-% related to the weight of fiber, into a 0.05 molar AgNO₃-solution. Since algae are natural products the relatively limited binding capacities for heavy metals vary. Different binding mechanisms play a role in the binding of heavy metals to algae. Thus the binding of heavy metals to algae is not specific. A manufacture of white products from these fibers is not possible. According to JP2005226209 nanoscale particles, for example, silver are distributed in polysaccharides such as chitin or chitosan and spun to fibers. The antibacterial effect is only achieved by combination of chitosan and chitin, respectively, and silver. According to EP0905289, silver bound as AgZrPO₄ and AgCaPO₄ or incorporated in zeolite or glass will be spun to fibers, exhibiting a bactericidal effect, in a solution of cellulose in a tertiary aminoxide. Also in WO2004081267 silver in the form of nano-particles is used, however, as a compound (AgZnPO₄, AgJ) or material such as triclosan or carbon-nanotubes, doped with silver ions.

The proposed solutions stated in the cited patent rights for providing anti-bacterial properties to material and cellulosic shaped bodies, use silver or silver compounds in a comparatively high concentration under use of, partially, time- and energy consuming process steps; a production of white products by these methods is not possible.

### OBJECT OF THE INVENTION

Object of the invention is to provide a cellulosic shaped body as well as a method for the production of cellulosic shaped bodies having anti-bacterial efficacy and, at the same time, a high degree of whiteness for use in the clothing sector, the paper production as well as in the medical sector and the hygienics. Thereby the manufacture of textile white products and high quality papers having a long shelf life has to be enabled. In order to ensure an even distribution of the particles, silver suspensions will be provided which, without employing further stabilizing agents, do not show any agglomeration. Further advantages will be disclosed in the following specifications.

The objective is realized in that a highly active nano-silver is used in a chemically reduced form, for example, according to EP1621217. When using nano-silver of particle sizes of 5-20 nm as a suspension in non-aqueous liquids, it is possible to reduce the contents of silver to amounts of 0.0025%, related to the fiber, preferably to 0.01%. These low amounts ensure a low intrinsic coloring with a high degree of whiteness and exhibit, at the same time, an anti-bacterial effect.

To integrate nano-silver as a metal into the fiber offers the following advantages compared to the above described methods:
The loading of the fiber is more precisely adjustable due to the possibility to exactly dose the addition of silver into the spinning solution,
An increased permanency of the bactericidal effect of the fiber can be expected.
The present reduced form of the silver offers the opportunity to bleach the fibers and to produce textiles with a high degree of whiteness.
The dyeing with known technologies becomes possible without any limitations.

The rate of surface atoms increases with decreasing particle sizes. Thus nano-particles very often show in their mechanical, optical, electric and magnetic properties significant differences compared to their coarse-grained counterparts. The atoms on the surface are in a raised energetic state, since they have a lower number of adjacent neighbors to be in interaction with. This leads to an increased chemical and catalytic, respectively, reactivity. [Rössler, A. et al., Chemie in unserer Zeit, 1, p. 32-41 (2001)]. Accordingly and due to its extremely large surface, nanoscale silver exhibits a considerably greater anti-microbial efficacy compared to conventional silver products with particle sizes exceeding 500 nm. The formation of an oxide layer (Ag₂O) will be accelerated by the great porosity. In this layer the silver ions (Ag) exist which are necessary for a bactericidal effect:

Ag₂O+H₂O→Ag⁺+OH⁻.

The controlled release of the silver ions is a decisive advantage of the nano-silver whereby a permanent bactericidal effect may be achieved and, in addition, the inertness towards mechanical stress, chemical reagents and light. Due to the latter it is possible to bleach and to dye the silver modified fibers; for it was surprisingly found that the fiber according to the present invention has no intrinsic coloring. Furthermore, it was found that it is very advantageous to add the nano-silver to the spinning solution as a suspension. Thus a very even distribution of the particles was obtained without the formation of aggregates which was proven by electron microscopic pictures of the fiber. The used suspension of the nano-silver in non-aqueous liquids proved to be very stable; stabilizing agents were not necessary.

To load the fibers with high concentrations of silver is not required due to the high bactericidal effect of the nano-silver. With concentrations below 0.01 mass-% the produced fiber has, already achieved an anti-bacterial efficacy. It is also possible to manufacture higher loaded fibers with concentrations up to 5000 ppm with the present method without any disadvantageous effect on the spinning stability, the thermal stability and the textile-physical parameters. These fibers may be set to the desired silver content in the yarn to be manufactured by blending with other fibers such as, for example, cotton or synthetic fibers. This kind of procedure permits a very economical production of yarns with bactericidal effects. In the same way the fibers may be processed to textile fabrics, preferably in a mixture with other fiber materials, or to papers.

The manufacture of the bioactive fiber is carried out by the Lyocell-process. Thereby cellulose will be dissolved in a solvent under addition of stabilizers and spun to cellulosic fibers by the dry/wet extrusion process or drawn to films. The addition of stabilizers to the spinning solution is necessary to maintain the thermal stability and to oppose the decomposition of the cellulose and of the solvent due to the technical conditions. PH-value stabilizers and complex forming substances and/or radical scavengers are employed as stabilizers. The combination of gallic acid propylester, hydroxylamine and sodium hydroxide from WO1995/08010 is a generally accepted stabilizer system well-proved under technical conditions. The solvent can be an aqueous tertiary amine oxide, preferably N-methylmorpholine-N-oxide (NMMO) or an ionic liquid, preferably 1-N-butyl-3-methylimidazolium chloride. The silver can be processed in the form of a suspension of nano-silver with particle sizes of 5-20 nm. As suspensions, liquids are used having a low vapor pressure, for example, silicon oil, without any stabilizing agents. Practically the addition is carried out in the form of a nano-silver suspension to avoid the agglomeration formation. Before the addition of the solvent and of the stabilizer, the nano-silver suspension will be deposited directly onto the cellulose in order to obtain later a homogenous distribution of the nano-silver particles in the spinning solution and still later in the fiber.

The present invention will be explained in more detail by the subsequently disclosed examples. The silver content in the fiber was determined by atom absorption spectrometry after dry incineration.

The anti-microbial efficacy was verified by a proliferation assay of the company Bio-Gate AG (NUMETRIKA™, Bechert et al., Nature Medicine 6, 1053-1056 (2000)). Thereby micro-organisms are specifically applied to the test specimens. After a complex but fast parallelized procedure, there will be tested whether or not adhering micro-organisms may still proliferate. When such a growth is prevented by the specific properties of the material, then the material is designated as anti-microbially effective. As a quantifiable parameter the so-called Onset-OD is used. That is the number of hours which the remaining daughter cells need to grow up at last to a cell culture of a defined optical density (0.2 OD). Anti-microbial efficacy will always be measured as a difference in a comparison to a non-antimicrobial, a so-called zero sample. To this end given samples are used as zero samples which are free from any anti-microbial additives, however, are entirely equal to the regular samples in all other respects. The average measuring value of the zero-sample will be subtracted from the measuring value of the proper sample (net Onset-OD). The degree of whiteness was determined according to DIN 5033 before and after exposure to a xenon radiator for 62 h by the device Datacolor SF600 (measuring conditions: with gloss, kind of light D65/10°. A higher value stands for a higher degree of whiteness.

By means of the reactive dye Remazol turquoise blue G (0.3% solution) the fibers were dyed for 60 min at 80° C. The dyeability was tested according to DIN 6174. Thereby the colormetrical determination of the color spacing was carried out by the color measuring device SF 600, Datacolor Company at the measuring geometry D65/10° and according to CIE-Lab-formula.

### EXAMPLES

### Example 1

In a kneader 5720 g of 60 percent NMMO (N-methylmorpholine-N-oxide) was added and 570 g of spruce cellulose with a residual moisture of 6.1 mass percent and a degree of polymerization (DP) of about 500 and 3.375 g nano-silver (0.8% silver in silicon oil, NanoSilver BG™ 5 to 20 nm) were added. Thereby the nano-silver was directly applied to the cellulose to ensure a homogeneous distribution in the solution. 0.06 mass percent gallic acid propylester, 0.1 mass percent hydroxylamine and 0.04 mass percent caustic soda related to the cellulose were added for stabilization. The reactor was closed and the slurry was stirred for 15 minutes at room temperature and subsequently a vacuum of 30 mbar was applied. The solution was homogenized in the kneader while the temperature was raised in steps to 90° C. Subsequently this spinning solution was spun at 90° C. through a spinneret having 450 apertures with an aperture diameter of 80 μm each. The drawing-off speed was 30 m/min. The multifilament fiber was guided through a plurality of washing baths for washing out the NMMO. The fibers were cut to 60 mm and dried.

### Example 2

The fibers were manufactured according to Example 1 and spun. 6.75 g nano-silver (0.8% silver in silicon oil, NanoSilver BG™, 5-20 nm) were added.

### Example 3

The fibers were manufactured according to Example 1 and spun. 13.5 g nano-silver (0.8% silver in silicon oil, NanoSilver BG™, 5-20 nm) were added.

TABLE 1

| | | Example 1 | Example 2 | Example 3 |
|---|---|---|---|---|
| Silver content in the | % | 0.005 | 0.01 | 0.02 |
| fiber, theoretical | | | | |
| Elongation cond. | % | 12.6 | 12.8 | 12.3 |
| Loop tenacity | cN/tex | 10.3 | 10.7 | 10.1 |

When nano-silver particles in the lower nanometer range are used in a solution, the problem of aggregate formation is not to be expected. Therefore the used concentrations with 0.005-0.02% were very low, in order to detect the lower limit of the utilizable range. There is not any effect on the textile-physical parameters to be detected due to the very low content of silver. However, the ratio of measured silver content to theoretical silver content is only about 50%.

TABLE 2

| | | Zero | | | |
|---|---|---|---|---|---|
| | | sample* | Example 1 | Example 2 | Example 3 |
| Silver content in | % | 0 | 0.0024 | 0.0047 | 0.0076 |
| the fiber, measured | | | | | |
| Degree of whiteness | | 26.4 | 52.9 | 34.8 | 14.1 |
| Degree of whiteness | | 46.5 | 58.1 | 38.9 | 13.5 |
| after 62 h irradiation | | | | | |
| with xenon lamp | | | | | |

*fiber without addition of silver

Higher measuring values with respect to the degree of whiteness are obtained with fibers having 0.0024% and 0.0047% nano-silver in suspension; this confirms the utilization of said fibers for white goods. A further slight increase of the degree of whiteness was noted after an intensive UV-irradiation. A non-loaded fiber (normal fiber) is, for the sake of comparison, also added in Table 3.

TABLE 3

| | | Zero | | | |
|---|---|---|---|---|---|
| | | sample* | Example 1 | Example 2 | Example 3 |
| Silver content in | % | 0 | 0.0024 | 0.0047 | 0.0076 |
| the fiber, measured | | | | | |
| Onset-OD gross | [h] | 6.1 | 28.2 | limits | limits |
| Onset-OD net | [h] | — | 8.3 | >48 | >48 |
| Test result | | — | anti- | bacteri- | bacteri- |
| | | | microbial | cidal | cidal |

*fiber without addition of silver

Already from a concentration of 0.0024% nano-silver in the fiber an anti-microbial efficacy could be measured. Fibers with a higher concentration showed a bactericidal effect.

TABLE 4

| | Bright- | Red-green- | Yellow- | Color | Color |
|---|---|---|---|---|---|
| | ness L | axis a | blue-axis | brilliancy C | shade H |
| Zero | 74.1 | −24.13 | −14.17 | 27.99 | 210.42 |
| sample* | | | | | |
| Example 1 | 74.81 | −24.19 | −14.73 | 28.32 | 211.35 |
| Example 2 | 74.58 | −22.82 | −10.00 | 24.92 | 203.67 |
| Example 3 | 72.34 | −23.48 | −7.41 | 24.62 | 197.51 |

*fiber without addition of silver

When dyeing with a reactive dye, the colormetrical measurements resulted in very good color brilliancy. Compared to the unloaded fiber a very low change of the color coordinates and of the parameters brightness, color brilliancy and color shade was noted.

1. Method for the production of cellulose shaped bodies with bioactive action and a high degree of whiteness, characterized in that there is added to a spinning solution which contains cellulose, a solvent for the cellulose and stabilizers, bactericidal effective metallic nano-silver of an average particle size of f5-20 nm, and in that the spinning mass is subsequently spun to shaped bodies by a dry-wet spinning process.

2. Method as claimed in claim 1, characterized in that metallic
nano-silver in the form of a nano-silver suspension is added without any
stabilizing agents.

3. Method as claimed in claim 1, characterized in that the solvent for the cellulose is a tertiary amine oxide, preferably N-methylmorpholine-N-oxide.

4. Method as claimed in claim 1, characterized in that the solvent for the cellulose is an ionic liquid, preferably l-N-butyl-3-methylimidazolium chloride, 1-N-butyl-3-methylimidazolium acetate, 1-N-ethyl-3-methylimidazolium chloride or 1-N-ethyl-3-methylimidazolium acetate.

5. Method as claimed in claim 1, characterized in that gallic acid propylester, hydroxylamine and sodium hydroxide in concentrations of from at least 0.01% to 0.5% are added as stabilizers to the spinning solution.

6. Method as claimed in claim 1, characterized in that nano-silver of particle 30 sizes of 5-20 nm is used as a suspension in non-aqueous liquids in amounts of minimum 0.0025%, related to the fiber, preferably 0.01%.

7. Method as claimed in claim 6, characterized in that the nano-silver in suspension is utilized in liquids of low steam pressure without stabilizing agents.

8. Method as claimed in claim 1, characterized in that the concentration of the nano-silver in the non-aqueous liquids is at least 0.1%, preferably 0.8 to 4%.

9. Method as claimed in claim 1, characterized in that the nano-silver is directly deposited upon the cellulose before the addition of solvent and stabilizer.

10. Bioactive cellulose fiber with a high degree of whiteness manufactured by the method according to claim 1.

11. Bioactive cellulose fiber with a good dyeability manufactured by the method according to claim 1.

12. Textile fabric with bioactive effect, manufactured out of the cellulose fiber according to claim 10, if necessary, under blending further textile fibers thereto.

13. Textile fabric according to claim 12, characterized in that the textile fibers are selected from the group which contains cotton, wool, polyester fibers, polyamide fibers, polyacrylic fibers, polypropylene fibers and cellulosic regenerated fibers.

14. Paper with bioactive effect and a high degree of whiteness manufactured from the fibers according to claim 10.
